(19) United States
(12) Patent Application Publication
(10) Pub. No.: US 2011/0120270 A1
(43) Pub. Date: May 26, 2011

(54) WELDED HAMMER

(75) Inventors: Keith M. Lombardi, Avon, CT (US); Joshua Brown, Beacon Falls, CT (US)

(73) Assignee: STANLEY BLACK & DECKER, INC., New Britain, CT (US)

(21) Appl. No.: 12/827,484

(22) Filed: Jun. 30, 2010

Related U.S. Application Data
(60) Provisional application No. 61/263,587, filed on Nov. 23, 2009.

(51) Int. Cl. B25D 1/04; B25D 1/12; B25G 1/12; B23P 15/00

(52) U.S. Cl. 81/22; 81/20; 254/26 R; 29/428

(57) ABSTRACT

A hammer includes a handle and a head. The handle includes a bottom end and an upper portion. The head is disposed on the upper portion of the handle. The head includes a bell portion at one end and a claw portion at the other end thereof. The handle, the bell portion, and the claw portion are separately formed structures. The handle and the claw portion are formed from stamped sheet metal. A weld connection is formed between the stamped sheet metal handle and the stamped sheet metal claw portion. A weld connection is formed between the stamped sheet metal claw portion and the bell portion.

This application relies on the benefit of priority from U.S. Provisional Application No. 61/263,587, filed on Nov. 23, 2009, which is incorporated herein by reference in its entirety.

### BACKGROUND OF THE INVENTION

### Field of the Invention

The present invention relates to hammers and more particularly to a hammer which is made from stamped or cold formed components.

Conventional hammers typically include a head fixedly secured to (i.e., a two-piece hammer) or integrally formed with (i.e., a one-piece hammer) a rigid handle. During use, a striking surface disposed on the head of the hammer is configured to strike against an object, such as a nail or chisel.

For the two-piece hammer, the head of the hammer is generally made from steel or other durable material. The head of the two-piece hammer may also be cast from a titanium metal material. The weight of the hammer having a titanium head can be approximately 40% less than the weight of the hammer having a steel head. The hammer with the titanium head is constructed and arranged to reduce user fatigue due to decreased weight. Although the hammer having the titanium head may not deliver as much energy to the object being stuck as the hammer with the steel head, the hammer with the titanium head is constructed and arranged to be swung faster which makes up for some or all of the loss in mass (Kinetic Energy (KE)=½*mass*(velocity)²). The handle of the two-piece hammer is generally made from wood, an injection molded handle with a fiberglass core, or other suitable material. The head of the two-piece hammer is typically mechanically attached to the handle.

The one-piece hammers are generally forged or cast so that the handle is made from the same material as the head of the hammer. The metal handle may be covered with a polymer, elastomeric, or other suitable grip to provide comfort and vibration resistance. Although the one-piece hammer is generally very strong, the steel material used for the head and a claw portion is also used for the handle which makes the one-piece hammer expensive. The one-piece hammer may also be cast from titanium material to reduce the weight of the hammer.

Hammers made by forging operation are generally considered to be strongest. However, the forging operation results in a high percentage (e.g., up to 50%) of the material being wasted due to the flash generated all around the part to aid material flow. The material cost is a significant factor in the overall cost of the manufacturing a hammer. Thus, hammers made by casting typically have a much higher material yield than forging and are therefore typically cheaper to manufacture.

The present invention provides improvements over the prior art hammers.

Aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein can be considered drawn to scale. It is to be expressly understood, however, that the drawings are for the purpose of illustration and description only and are not intended as a definition of the limits of the invention. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 is a perspective view of a hammer in accordance with an embodiment of the present invention;

FIG. 2 is a left hand side elevational view of the hammer in accordance with an embodiment of the present invention;

FIG. 3 is a right hand side elevational view of the hammer in accordance with an embodiment of the present invention;

FIG. 4 is a front view of the hammer in accordance with an embodiment of the present invention;

FIG. 5 is a rear view of the hammer in accordance with an embodiment of the present invention;

FIG. 6 is a top view of the hammer in accordance with an embodiment of the present invention;

FIG. 7 is a bottom view of the hammer in accordance with an embodiment of the present invention;

FIG. 8 is a schematic illustration of a method of forming a hammer in accordance with an embodiment of the present invention; and

FIG. 9 is a schematic illustration of a method of forming a hammer in accordance with another embodiment of the present invention.

### DETAILED DESCRIPTION OF THE INVENTION

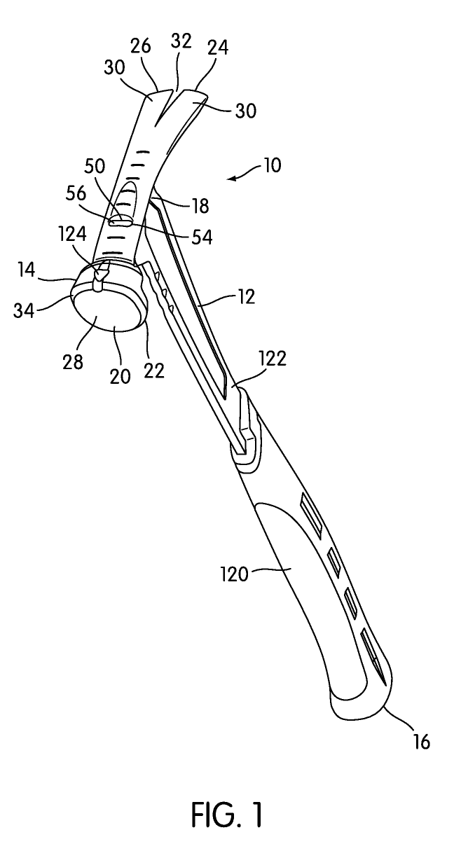

FIGS. 1-7 show a hammer 10 in accordance with an embodiment of the present invention. The hammer 10 includes a handle 12 and a head 14. The handle 12 includes a bottom end 16 and an upper portion 18. The head 14 is disposed on the upper portion 18 of the handle 12. The head 14 includes a bell portion 20 at one end 22 and a claw portion 24 at the other end 26 thereof. The handle 12, the bell portion 20, and the claw portion 24 are separately formed structures. In one embodiment, the handle 12 and the claw portion 24 can be formed from stamped sheet metal, although in other embodiments the handle and/or the claw portion may be formed separately by cold forming, forging, rolling, extrusion, metal injection molding, or casting. A weld connection 50 is formed between the stamped sheet metal handle 12 and the stamped sheet metal claw portion 24. A weld connection 52 is formed between the stamped sheet metal claw portion 24 and the bell portion 20.

In one embodiment, the bell portion 20 is formed from cold formed metal. In other embodiments, the bell 20 may be forged, cast, rolled, or formed from stamped sheet metal, extrusion, or metal injection molding. In one embodiment, the handle 12, the claw portion 24, and the bell portion 20 are formed from dissimilar materials.

In one embodiment, the claw portion 24 and the bell portion 20 are integrally formed by a forging operation, and a weld connection is formed between the stamped sheet metal handle 12 and integrally forged claw portion and bell portion.

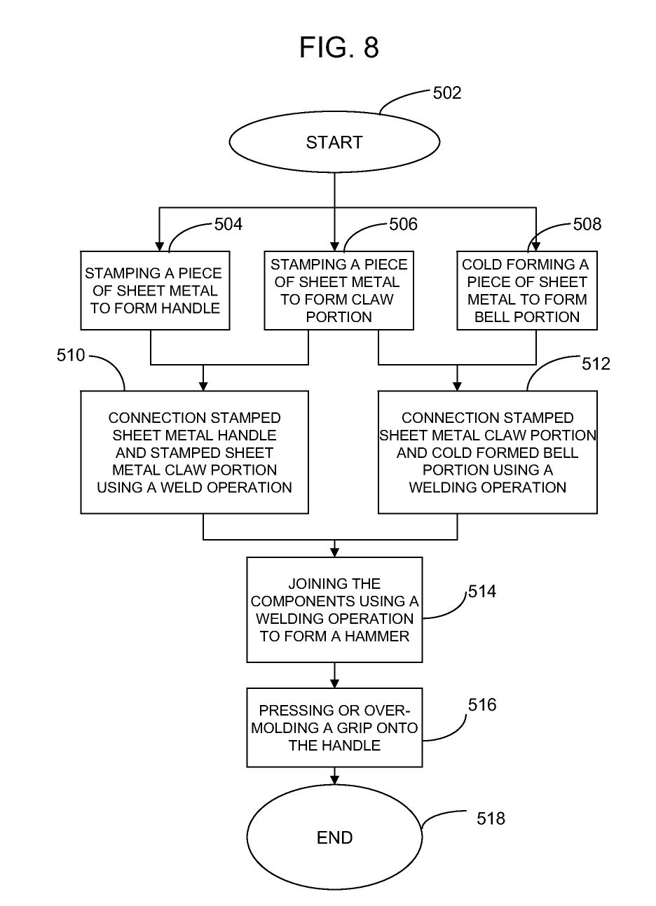

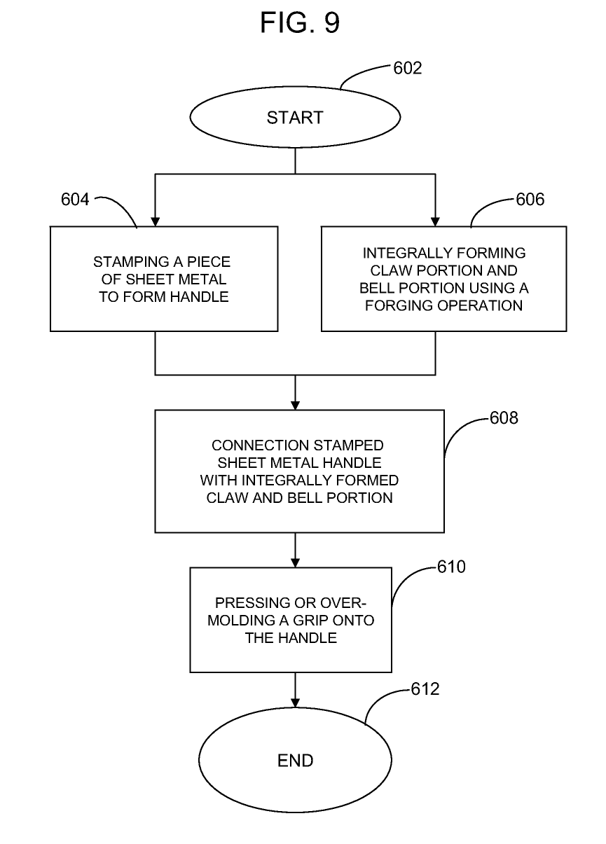

In one embodiment, a method of making a hammer is provided (i.e., as described in detail with respect to FIGS. 8 and 9). In one embodiment, the method includes stamping a first piece of sheet metal to form handle; providing a claw portion and a bell portion; connecting the stamped handle to the claw portion; and connecting the claw portion and the bell portion.

As noted above, the head 14 of the hammer 10, which is disposed on the upper portion 18 of the handle 12, includes the bell portion 20 at one end 22 and the claw portion 24 at the other end 26 thereof.

In the illustrated embodiment shown, the claw portion 24 of the head 14 includes a pair of tapered, spaced-apart (forked) nail removing members 30 (e.g., see FIGS. 1, 6 and 7). The nail removing members 30 provide a V-shaped or triangular space 32 therebetween. The shank of a nail can be received in the V-shaped space 32 with the top of the hammer 10 facing the work piece and the nail is removed by engaging the spaced apart claw members 30 with the head of the nail and withdrawing the nail from a work piece.

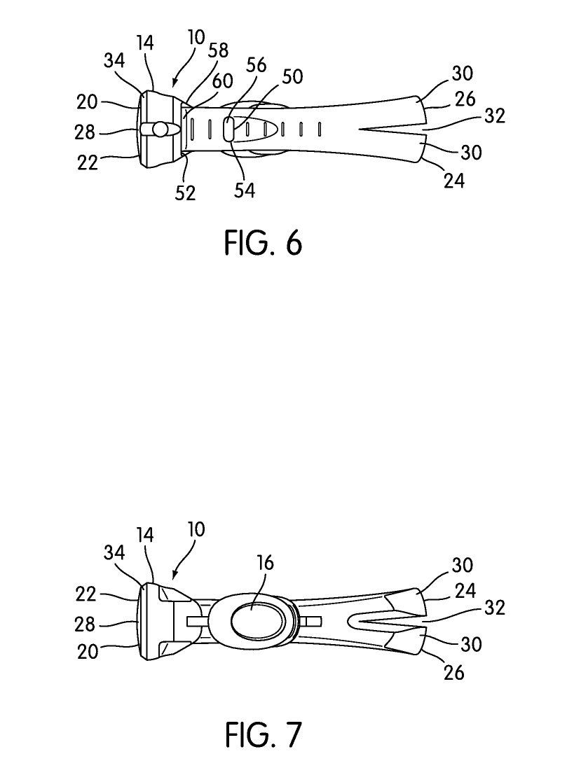

In some embodiments, a forked claw portion is not provided, but rather a single rearwardly extending portion is provided, as is known in masonry applications. Such single rear portion is not typically considered to be a “claw” in the art, as a single rear portion has a different function and purpose than a nail pulling claw. For convenience and for the purposes of the claims contained in this application, however, the term “claw portion” as used herein should be construed broadly to cover a single rear extension as well as the forked arrangement. In one embodiment, the claw portion 24 of the head 14 may include handle receiving opening(s) 54 (as shown in FIGS. 1 and 6) that are constructed and arranged to receive a portion 56 of the handle 12, when securing the claw portion 24 to the handle 12 using a welding operation.

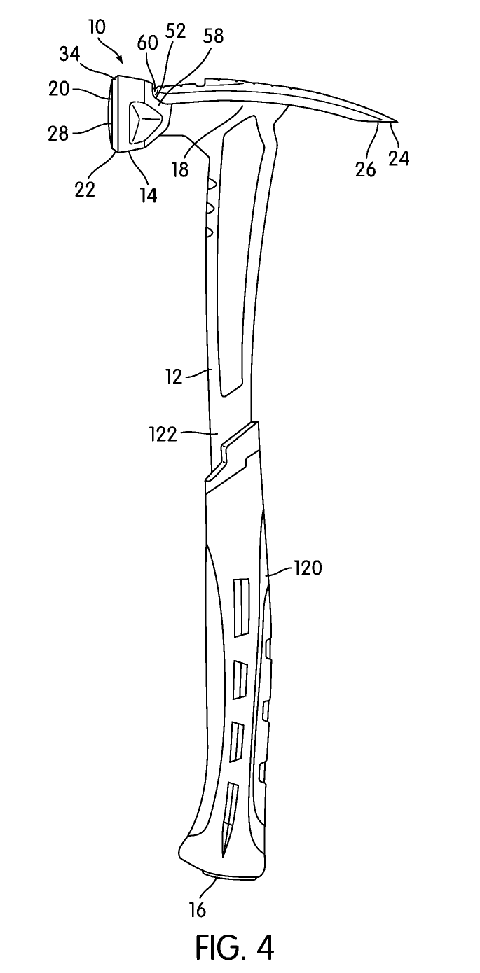

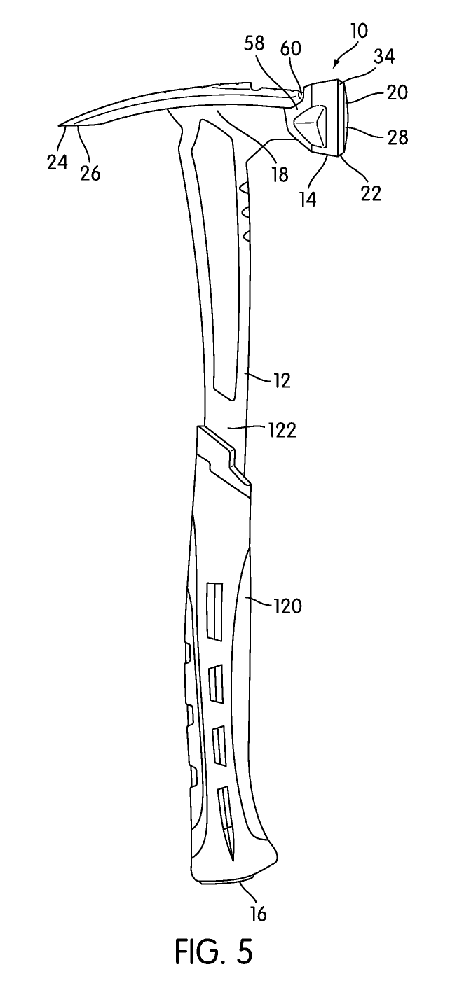

The bell portion 20 of the head 14 located at the forward portion of the head 14 of the hammer 10 includes a striking surface 28. A chamfer or bevel 34 is located circumferentially along the edges of the striking surface 28 of the hammer 10. When the hammer 10 is swung in a swing plane of the hammer, the striking surface 28 strikes an object, such as a nail or a chisel. In one embodiment, the striking surface 28 of the hammer 10 is slightly convex in order to facilitate square contact during driving of nails. In one embodiment, the bell portion 20 of the head 14 may include claw portion receiving portion 58 (as shown in FIGS. 4 and 5) that is constructed and arranged to receive a portion 60 of the claw portion 24, when securing the bell portion 20 to the claw portion 24 using a welding operation.

In one embodiment, an additional or extra portion of the hammer's mass may be concentrated in the bell portion 20 or behind the strike surface 28. During use the hammer generally rotates along the handle axis due to the mass of the claw portion, which continues forward after the blow has been delivered. This rotation may cause fatigue to the user since the user must continuously try to counter the rotation of the hammer during the striking by the squeezing the grip harder. The hammer 10 of the present invention is constructed and arranged to counter the rotation of the hammer during the striking of the object by concentrating more of the hammer's mass in the bell portion 20 or behind the strike surface 28.

FIGS. 1-7 show views of the illustrative hammer 10 in its assembled condition. In one embodiment, the components of the hammer, such as the handle 12, the claw portion 24 and the bell portion 20, may be made from materials that are selected for their intended use and cost. For example, a steel hammer having a weight similar to that of a titanium hammer may be economically produced. In one embodiment, the handle 12, the bell portion 20, and the claw portion 24 are separately formed structures that are each formed from dissimilar materials. In one embodiment, the components (i.e., the claw portion 24, the bell portion 20 and the handle 12) of the hammer 10 may be constructed of any suitable metallic material.

In one embodiment, the claw portion 24 is made from high carbon spring steel material. The high carbon steel material provides not only high hardness but also high yield strength to the claw portion (24. In one embodiment, the claw portion 24 is formed from stamped sheet metal.

In one embodiment, the bell portion 20 is made from a shock resistant tool steel to withstand impact. In one embodiment, the bell portion 20 may be made from a cold forming operation or a cold heading operation. In another embodiment, the bell portion 20 may be made from a metal injection molding (MIM) operation. In such embodiment, the bell portion 20 may be made using a powered metal material. The metal injection molding is configured to eliminate the need for secondary forming operations on the bell portion 20. For example, the “waffle” pattern that is generally machined onto a strike surface 28 of the head 14 may be made during the same operation that makes the bell portion 20.

In one embodiment, the handle 12 is made of metal, a composite material, or a synthetic material. In another embodiment, the handle 12 of the hammer 10 is made of a lighter material, such as wood, aluminum, a plastic material, a fiberglass material, or other suitable material. In one embodiment, the handle 12 of the hammer 10 is made from stamped sheet metal. In one embodiment, the handle 12 may be made from a low carbon steel material. When the hammer 10 undergoes a heat treatment process, the low carbon steel material provides the handle 12 with a lower hardness, which in turn provides a vibration dampening for the hammer 10.

As shown in FIGS. 1-5, the hammer 10 includes a manually engageable gripping portion 120. In one embodiment, the manually engageable gripping portion 120 of the hammer 10 is molded onto an inner or core portion 122 of the handle 12. In one embodiment, the gripping portion 120 of the handle 12 is made of an elastomeric material, a rubber based material, a plastic based material or other suitable material. Optionally, the gripping portion 120 can be ergonomically shaped. In another embodiment, the gripping portion is simply the outer surface of the handle material (e.g., wood or metal).

In one embodiment, the manually engageable gripping portion 120 (e.g., made from a plastic based material) may be partially or entirely over-molded onto the inner or core portion 122 of the handle 12 to mimic the appearance of the two-piece hammer, for example. The over-molded plastic portion may serve as a protective covering for environments where metal to metal contact may damage portion of the hammer that is being struck. For example, the hammer with the over-molded plastic portion may provide different functions, such as spark resistance, overstrike protection, or simply provide an aesthetic appearance.

In one embodiment, the hammer 10 may optionally include an over-strike protector structure constructed and arranged to surround a portion of the handle 12 adjacent to (beneath) the upper portion 18 of the handle 12. The over-strike protector structure is constructed and arranged to protect the handle 12 and/or reduce vibration imparted to the user's hand during an overstrike (i.e., when a striking surface 28 of the hammer 10 misses an intended object, such as nail or a chisel, and the handle 12 strikes the wood or other surface). In one embodiment, the over-strike protector structure includes an additional or extra layer or mass of resilient material (such as an elastomer or rubber based material) molded on the portion of the handle 12 to dissipate impact energy and stress due to an overstrike. In one embodiment, the over-strike protector structure is constructed and arranged to provide a high degree of cushioning to protect the user's hand from the kinetic energy transferred thereto during impact of the striking surface against the object, such as a nail or a chisel.

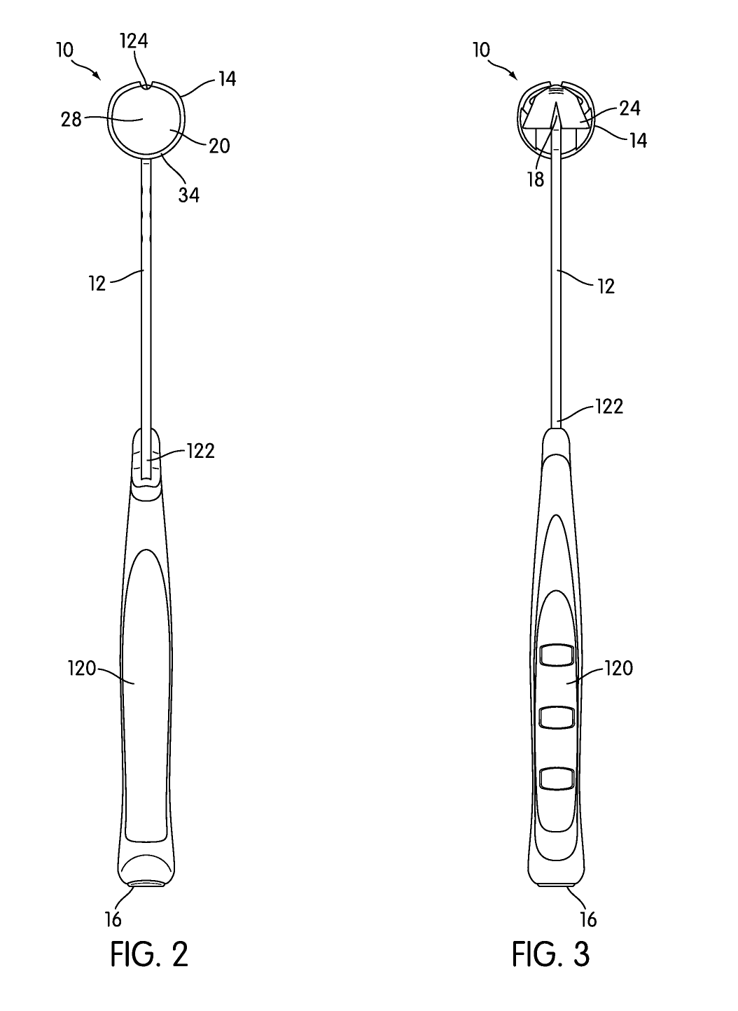

As shown in FIGS. 1 and 2, in one embodiment, a groove 124 may be located along a top surface of the bell portion 20. The groove 124, if provided, is constructed and arranged to receive and retain the head portion of a nail (not shown) therein, when the nail is placed in an initial nail driving position to facilitate the start of a nail driving operation.

In one embodiment, the strike surface 28 may be made larger while keeping the overall weight of the hammer 10 lower (i.e., when compared to traditional hammers made from steel). In one embodiment, a ratio of head weight of the hammer, measured in ounces at 3.0 inches from top of the head, to surface area of the striking surface of the head measured in square inches, is less than 16.25. In another embodiment, a ratio of the head weight of the hammer measured in ounces to the surface area of the striking surface of the head measured in square inches is less than 14.0. A hammer having such a large strike surface configuration is described in a U.S. Application Ser. No. 12/436,035, filed on May 18, 2009, the entirety of which is hereby incorporated into the present application by reference.

FIG. 8 shows a schematic illustration of a method 500 of forming a hammer in accordance with an embodiment of the present invention. The method 500 begins at procedure 502. At procedure 504, a first piece of sheet metal is stamped to form the handle 12. A second piece of sheet metal is stamped to form the claw portion 24 at procedure 506. At procedure 508, a third piece of metal is cold formed to form the bell portion 20.

After the components (i.e., the claw portion 24, the handle 12 and the bell portion 20) of the hammer 10 are formed by stamping or cold forming, the handle 12, the claw portion 24 and the bell portion 20 are secured to one another as explained in procedures 510, 512 and 514.

At procedure 510, the stamped sheet metal handle is connected to the stamped sheet metal claw portion using a welding operation. At procedure 512, the stamped sheet metal claw portion is connected to the cold formed bell portion using a welding operation.

The method 500 then proceeds to procedure 514, where the components formed during the procedures 510 and 512 are joined together using a welding operation to form the hammer 10.

In one embodiment, the welding operation may include a Gas Metal Arc Welding (GMAW) or a Metal Inert Gas Welding (MIGW). For example, in GMAW process, a continuous and consumable wire electrode and a shielding gas are fed through a welding gun to make the weld connection.

In another embodiment, the claw portion 24, and the bell portion 20 may be secured to each other using two exemplary welding operations as described below. Since the welding operation used to secure the handle 12 to the claw portion 24 can be similar to the welding operation to secure the claw portion 24 to the bell portion 20, the welding operation used to secure the handle 12 to the claw portion 24 is not described here in detail.

During the welding operation, the claw portion 24 is placed in contact with projection portions on the bell portion 20 of the hammer 10 and an electrical current and force is applied to the bell portion 20 and the claw portion 24 of the hammer 10. For example, the portion 60 (as shown in FIGS. 4 and 5) of the claw portion 24 is received by the claw portion receiving portion 58 (as shown in FIGS. 4 and 5). The applied electrical current flows through the projection portions on the bell portion 20 of the hammer 10 and through the claw portion 24 of the hammer 10. The applied electrical current establishes an electrical current of sufficient density flowing through the projection portions to heat the projection portions sufficiently to cause the metallic material of the portions to soften. The applied force moves the bell portion 20, and the softened metallic material from the projection portions toward the claw portion 24 thereby forming the welded connection 52 (as shown in FIG. 6) between the claw portion 24 and the bell portion 20 of the hammer 10.

The projection portions may have any constructions and cross-sectional shapes, for example, triangular, square, rectangular, rounded, half-moon shaped or semi-circular, semi-oval. In one embodiment, the projection portions may be substantially equal in size to one another when viewed in cross-section. In another embodiment, the projection portions may be of unequal size to one another and may be of different constructions and cross-sectional shapes from one another. In one embodiment, the number of projection portions that are located on the bell portion 20 can vary significantly in number.

In the first exemplary welding operation (i.e., used to secure the claw portion 24 and the bell portion 20 of the hammer 10), the claw portion 24 is placed in contact with the projections portions of the bell portion 20. Two electrically conductive members or electrodes are generally placed such that the first conductive member is placed against outwardly facing surface of the claw portion 24 of the hammer 10 and the second conductive member is placed against outwardly facing side surface of the bell portion 20 of the hammer that is opposite the outwardly facing side surface of the claw portion 24 of the hammer 10. The claw portion 24 and the bell portion 20 are constructed of electrically conductive materials.

The conductive members may be a copper electrode, for example. Each conductive member may be electrically connected to a respective terminal of a power source which may be a current source, for example. The power source may operate to provide a direct (DC) or alternating (AC) electrical current to the conductive members or both simultaneously or alternately. The source can be controlled to produce an electrical current having the characteristics desired. For example, in instances in which the source produces a direct current, the magnitude (amperage), duration and direction of the electrical current can each be independently controlled during a welding operation. In instances in which the source produces an alternating electrical current, the characteristics of the current waveform including the magnitude, frequency, wave shape, and duration can each be independently controlled during a welding operation.

One or both conductive members is operatively connected to a source of mechanical power (e.g., a hydraulic assembly or an air cylinder) and both conductive members cooperate to exert a controlled force (that is, a controllable force) on the claw portion 24 and on the bell portion 20 in a direction which tends to move the claw portion 24 towards the bell portion 20.

In one embodiment, a force may be exerted on the claw portion 24 by the first conductive member and the second conductive member may be rigidly secured in a fixed position so that the second conductive member provides a fixed support surface for supporting the bell portion 20 during weld formation.

Prior to the commencement of the current flow, the inwardly facing side surface of the claw portion 24 of the hammer 10 is in contact with the projection portions on the bell portion 20. After the electrical current is commenced, the electrical current flows through the claw portion 24 and the bell portion 20 of the hammer 10 through the projection portions. The density of the current flowing through the projection portions is high relative to the current density flowing through the claw portion 24 or through the bell portion 20 of the hammer 10. The projection portions therefore function, in effect, as energy directors which tend to concentrate the current flowing between the bell portion 20 and the claw portion 24 and thereby increase the current density in the projection portions.

A current of sufficient magnitude is established in the projection portions to cause the projection portions to heat the projection portions to a temperature at which the yield strength of the metallic material comprising the projection portions is lowered sufficiently to cause the metallic material of the projection portions to soften or, alternatively, to flow. As the current is being applied, the conductive members exert force (which force may be constant or variable in various embodiments of the invention) on the claw portion 24 and on the bell portion 20. The clamping force causes the metallic material of the projection portions to collapse or deform and to spread out between the inwardly facing side surface of the claw portion 24. The second conductive member is constructed and positioned to apply a force to the claw portion 24 during a welding operation. Because the second conductive member is in contact with the claw portion 24, the claw portion 24 moves in dimensional unison toward the bell portion 20.

The projection portions, described in the above embodiment, are formed on the bell portion 20 of the hammer 10. In another embodiment, the projection portions may be formed on the claw portion 24 of the hammer 10.

Other known welding operations may alternatively be used.

After the weld is formed between the claw portion 24 and the bell portion 12, the welded area may be brittle. The brittleness of the welded area may optionally be substantially reduced or eliminated by tempering each weld area. For example, the brittleness of the weld area may be reduced or eliminated by passing a lower current (lower relative to the magnitude of the electrical current used during weld formation) for a predetermined amount of time through the conductive member and through the welded area of the hammer. This relatively low current tempers the welded area to a desired level of hardness. For example, the hardness of the welded area can be reduced by applying a relatively low current to the welded area to give each welded area a hardness of approximately 45 HRC. In one embodiment, the weld area may be tempered to any hardness (e.g., within the range of from approximately 70 Rockwell Hardness B (HRB) to approximately 45 HRC) by varying the temperature of the weld and/or the welding time.

After the projection portions have been made smaller or disappeared, the engaging surfaces of the bell portion 20 can be substantially flush with the engaging surfaces of the claw portion 24. A quenching operation and/or a tempering operation may optionally be carried out after formation of the weld.

In the second exemplary welding operation (i.e., used to secure the claw portion 24 and the bell portion 20 of the hammer 10), a thin piece of metallic material or foil is placed between the projection portions and the claw portion 24. The foil piece can be used to carry out a resistance braze-type of welding operation.

The foil piece may be constructed of a variety of different metallic materials and may have a variety of different properties. For instance, in one example of a resistance braze welding, operation, the foil piece has a lower melting point than the melting point of the metallic material used to construct the claw portion 24 and the foil piece has a lower melting point than the melting point of the metallic material used to construct the bell portion 20 (including the projection portions integrally formed on the bell portion 20). The foil piece may also have a higher bulk resistance (i.e., a higher resistance to the passage of electrical current) than either the material used to construct the claw portion 24 or the material used to construct the bell portion 20. The metallic material used to construct the foil piece is also preferably metallurgically compatible with the metallic material used to construct the claw portion 24 and with the metallic material used to construct the bell portion 20.

Examples of some materials that may used to construct the foil piece include stainless steel, copper, or Inconel™. Any of these materials may be used to construct the foil piece in instances in which the claw portion 24 and the bell portion 20 are each constructed of appropriate respective grades of steel, for example.

To secure the claw portion 24 with the bell portion 20, the power source is energized which causes an electrical current to flow between the conductive members. This electrical current flows through the claw portion 24, through the foil and through the bell portion 20. A force is applied by the conductive members to the claw portion 24, and to the bell portion 20. The force tends to move the claw portion 24 toward the bell portion 20. In one embodiment, a force is applied by both conductive members, but in other instances a force can be applied by only one conductive member and the other conductive member can be fixed and function to support the bell portion 20 under pressure from the other member.

A welded connection 52 (as shown in FIG. 6) is made by applying an electrical current and a force to the bell portion 20. The applied electrical current flows through the projection portions and through each sheet of metallic material or foil and through the bell portion 20. The electrical current in the projection portions and in the foil has a density sufficient to cause the metallic material of the projection portions to soften or, alternatively, to flow locally, and to cause the metallic material of each sheet of metallic material or foil to soften or flow locally. The force moves the bell portion 20 and softened metallic material from the projection portions and the softened or flowing metallic material from each sheet of metallic material or foil to form a welded connection 52 (as shown in FIG. 6) between the bell portion 20 and the claw portion 24.

After the projection portions have been made smaller or disappeared, the engaging surfaces of the bell portion 20 can be substantially flush with the engaging surfaces of the claw portion 24. A quenching operation and/or a tempering operation may optionally be carried out after formation of the weld.

After the hammer 10 is formed at procedure 514, the method 500 proceeds to procedure 516. At procedure 516, the manually gripping portion is pressed or over-molded onto the handle 12. The method 500 ends at procedure 518.

As noted previously, the welding operations disclosed herein are only exemplary. Other welding operations may also be used.

In one embodiment, the claw portion 24, the bell portion 20, and the handle 12 of the hammer 10 may be made using a forging operation. In such an embodiment, the claw portion 24, the bell portion 20, and the handle 12 of the hammer 10 may be made using hot forging operation and/or cold forging operation.

FIG. 9 shows a schematic illustration of a method 600 of forming a hammer in accordance with another embodiment. In this method, the stamped components of the hammer 10 (e.g., the handle 12) are secured to forged or machined components of the hammer 10 (e.g., the claw portion 24 and the bell portion 20 are integrally formed using a forging operation).

The method 600 begins at procedure 602. At procedure 604, a first piece of sheet metal is stamped to form the handle 12. At procedure 606, the claw portion 24 and the bell portion 20 are integrally formed together as a unitary structure using a forging operation.

The method 600 then proceeds to procedure 608. At procedure 608, the stamped sheet metal handle is connected to the integrally formed claw and the bell portion using a welding operation. That is, at procedure 608, the components formed during the procedures 604 and 606 are joined together using a welding operation to form the hammer 10. Any welding operation may be used at procedure 608 to form the hammer 10.

At procedure 610, a manually gripping portion may be pressed or over-molded onto the handle 12. The method 600 ends at procedure 612.

The conductive members used in the welding operation described above may have a hardness within the range of from approximately 70 Rockwell Hardness B (HRB) to approximately 45 HRC. Each conductive member may have an electrical conductivity of between approximately 40% International Annealed Copper Standard (IACS) and approximately 90% IACS. This level of electrical conductivity for the conductive members may be achieved by constructing each conductive member from a Class 2 or Class 3 copper. The welding operation described above may be carried out using an alternating or direct current. For example, the power source may be operated to provide a current to the conductive members having a frequency of 60 cycles per second (cps). In this instance, each welding operation may be performed during approximately one current cycle up to approximately four current cycles (i.e., in at time period of from approximately 0.008 seconds up to approximately 0.100 seconds). During each welding operation, a peak electrical current of approximately 70 kilo amps (KA) to 200 KA or approximately 50 KA RMS (root mean squared) to 150 KA RMS may be applied through each conductive member.

A quenching operation and/or a tempering operation may optionally be carried out after the welding operation is performed. For example, after the claw portion 24 is welded to the bell portion 20, and/or the claw portion 24 is welded to the handle 23, the welded connections 50 and 52 may be quenched for between 1 and 15 seconds. After quenching, the welded connections 50 and 52 may be tempered.

Although the invention has been described in detail for the purpose of illustration, it is to be understood that such detail is solely for that purpose and that the invention is not limited to the disclosed embodiments, but, on the contrary, is intended to cover modifications and equivalent arrangements that are within the spirit and scope of the appended claims. In addition, it is to be understood that the present invention contemplates that, to the extent possible, one or more features of any embodiment can be combined with one or more features of any other embodiment.

What is claimed is:

1. A hammer comprising:
a handle, the handle having a bottom end and an upper portion;
a head disposed on the upper portion of the handle, the head having a bell portion at one end and a claw portion at the other end thereof;
the handle, the bell portion, and the claw portion being separately formed structures;
wherein the handle and the claw portion are formed from stamped sheet metal;
a weld connection between the stamped sheet metal handle and the stamped sheet metal claw portion; and
a weld connection between the stamped sheet metal claw portion and the bell portion.

2. The hammer of claim 1, wherein the bell portion is formed from cold formed metal.

3. The hammer of claim 1, wherein the handle, the claw portion and the bell portion are formed from dissimilar materials.

4. The hammer of claim 1, wherein the bell portion includes a striking surface.

5. The hammer of claim 1, wherein the claw portion includes a pair of spaced-apart nail removing members.

6. The hammer of claim 4, wherein the head further comprises a chamfer circumferentially along edges of the striking surface.

7. The hammer of claim 1, wherein the bell portion is made from a shock resistant tool steel material.

8. The hammer of claim 1, wherein the claw portion is made from a high carbon spring steel material.

9. The hammer of claim 1, wherein the handle is made from a low carbon steel material.

10. The hammer of claim 1, wherein the handle is made from an aluminum material.

11. The hammer of claim 1, further comprising an over-strike protector structure constructed and arranged to surround a portion of the handle, the over-strike protecting structure is constructed and arranged to allow the hammer to be dielectrically isolated.

12. A hammer comprising:
a handle, the handle having a bottom end and an upper portion; and
a head disposed on the upper portion of the handle, the head having a bell portion at one end thereof and a claw portion at the other end thereof;
the handle, the bell portion, and the claw portion being separately formed structures;
wherein the bell portion is formed from cold formed metal; and
a weld connection between the claw portion and the cold formed metal bell portion.

13. The hammer of claim 12, wherein the handle and the claw portion are formed from stamped sheet metal.

14. The hammer of claim 13, wherein a weld connection is formed between the stamped sheet metal handle and the stamped sheet metal claw portion.

15. The hammer of claim 12, wherein the handle, the claw portion and the bell portion are formed from dissimilar materials.

16. The hammer of claim 12, wherein the bell portion includes a striking surface.

17. The hammer of claim 12, wherein the claw portion includes a pair of tapered, spaced-apart nail removing members.

18. The hammer of claim 16, wherein the head further comprises a chamfer circumferentially along edges of the striking surface.

19. The hammer of claim 12, wherein the bell portion is made from a shock resistant tool steel material.

20. The hammer of claim 12, wherein the nail removing portion is made from a high carbon spring steel material.

21. The hammer of claim 12, wherein the handle is made from a low carbon steel material.

22. The hammer of claim 12, wherein the handle is made from an aluminum material.

23. The hammer of claim 12, further comprising an over-strike protecting structure constructed and arranged to surround a portion of the handle, the over-strike protecting structure is constructed and arranged to allow the hammer to be dielectrically isolated.

24. A hammer comprising:
a handle, the handle having a bottom end and an upper portion; and
a head disposed on the upper portion of the handle, the head having a bell portion at one end thereof and a claw portion at the other end thereof;
wherein the handle, the claw portion and the bell portion are formed from dissimilar materials.

25. The hammer of claim 24, wherein the handle, the bell portion, and the claw portion being separately formed structures.

26. The hammer of claim 25, wherein the handle and the claw portion are formed from stamped sheet metal.

27. The hammer of claim 26, wherein the bell portion is formed from cold formed metal.

28. The hammer of claim 27, wherein a weld connection is formed between the stamped sheet metal handle and the stamped sheet metal claw portion.

29. The hammer of claim 27, wherein a weld connection is formed between the stamped sheet metal claw portion and the cold formed metal bell portion.

30. The hammer of claim 24, wherein the bell portion includes a striking surface.

31. The hammer of claim 24, wherein the claw portion includes a pair of tapered, spaced-apart nail removing members.

32. The hammer of claim 30, wherein the head further comprises a chamfer circumferentially along edges of the striking surface.

33. The hammer of claim 24, wherein the bell portion is made from a shock resistant tool steel material.

34. The hammer of claim 24, wherein the nail removing portion is made from a high carbon spring steel material.

35. The hammer of claim 24, wherein the handle is made from a low carbon steel material.

36. The hammer of claim 24, wherein the handle is made from an aluminum material.

37. The hammer of claim 24, further comprising an over-strike protecting structure constructed and arranged to surround a portion of the handle, the over-strike protecting structure is constructed and arranged to allow the hammer to be dielectrically isolated.

38. A method of making a hammer, the method comprising:
stamping a first piece of sheet metal to form handle;
providing a claw portion and a bell portion;
connecting the stamped handle to the claw, portion; and
connecting the claw portion and the bell portion.

39. The method of claim 38, wherein the providing the claw portion and the bell portion comprises stamping a second piece of sheet metal to form the claw portion.

40. The method of claim 38, wherein the providing the claw portion and the bell portion comprises cold forming a third piece of metal to form the bell portion.

41. The method of claim 38, wherein the connecting the stamped handle to the claw portion comprises forming a weld connection between the stamped handle and the claw portion.

42. The method of claim 38, wherein the connecting the claw portion and the bell portion comprises forming a weld connection between the claw portion and the bell portion.
